(19) United States
(12) Patent Application Publication
(10) Pub. No.: US 2025/0254781 A1
(43) Pub. Date: Aug. 7, 2025

(54) AUTOMATIC CONTROL SIGNAL TRANSMISSION SYSTEM BASED ON PLURALITY OF SUB REPEATERS

(71) Applicant: HYBE Co., Ltd., Seoul (KR)

(72) Inventors: Bo Yoon CHOI, Seoul (KR); Sung Joo JEONG, Seoul (KR)

(73) Assignee: HYBE Co., Ltd., Seoul (KR)

(21) Appl. No.: 19/043,147

(22) Filed: Jan. 31, 2025

(30) Foreign Application Priority Data
Feb. 2, 2024 (KR) 10-2024-0016864
Apr. 24, 2024 (KR) 10-2024-0054875

(51) Int. Cl. H05B 47/19; H04W 88/04; H05B 47/165

(52) U.S. Cl. CPC H05B 47/19; H05B 47/165; H04W 88/04

(57) ABSTRACT

A method for automatically transmitting a control signal based on a plurality of sub repeaters according to an embodiment of the present disclosure is a method for automatically transmitting a control signal based on a plurality of sub repeaters to provide a theme production service in an automatic transmission program executed by at least one processor of a main repeater and includes linking to a plurality of sub repeaters having a plurality of prestored libraries and a terminal, transmitting command data to at least one of the plurality of linked sub repeaters, and performing control so that the sub repeater receiving the command data automatically transmits a control signal for activating the library included in the command data, and the command data includes at least one of a sub repeater serial number, a library serial number, and setting information.

### BACKGROUND

### Field

The present disclosure relates to an automatic control signal transmission system based on a plurality of sub repeaters. More specifically, the present disclosure relates to an automatic control signal transmission system based on a plurality of sub repeaters that allows a light emitting device to automatically reproduce a predetermined received pattern, by automatically transmitting a signal for controlling the light emitting device so that the light emitting device emits light in the predetermined pattern.

### Description of Related Art

A light emitting device is manufactured to display various colors and generate a spectacular effect in a dark space, and is used not only as a cheering tool at a concert and a showcase, but also for night activities and various events such as sports events, festivals, and parades.

Recently, light emitting devices allow various productions at an event by an administrator controlling light emitting devices owned by people, such as a combination of several light emitting devices creating specific letters and shapes, beyond a simple cheering tool.

However, the light emitting devices are still only used as part of the production at concert halls, and in a situation in which a place changes or a small number of people gather outside compared to a scale of a concert, it is difficult for the light emitting devices to be utilized due to transmission distance restrictions, place restrictions, and the absence of an administrator.

Further, even in a situation in which control is not necessary, such as complex performance production, an operator for performing the production is essential, and therefore, there is also a problem of human resources being wasted.

Therefore, discussions are being held to expand a range of production using light emitting devices.

### PRIOR ART DOCUMENT

### Patent Document

(Patent document 1) KR 10-1685411 B1

### SUMMARY

The present disclosure has been made to solve the problems of the related art described above, and an object of the present disclosure is to provide an automatic control signal transmission system based on a plurality of sub repeaters in which, when a main repeater transmits command data for controlling a plurality of sub repeaters disposed at a plurality of places, each sub repeater automatically transmits a predetermined control signal according to the transmitted command data to a light emitting device within a preset distance.

Further, another object of the present disclosure is to provide an automatic control signal transmission system based on a plurality of sub repeaters that escapes an existing operating system in which direct control by an operator is essential.

Further, still another of the present disclosure is to provide an automatic control signal transmission system based on a plurality of sub repeaters that supports a constant/repeated/periodic event production format.

However, technical problems to be achieved by the present disclosure and embodiments of the present disclosure are not limited to the technical problems described above, and there may be other technical problems.

A method for automatically transmitting a control signal based on a plurality of sub repeaters according to an embodiment of the present disclosure is a method for automatically transmitting a control signal based on a plurality of sub repeaters to provide a theme production service in an automatic transmission program executed by at least one processor of a main repeater according to an embodiment of the present disclosure and includes: linking to a plurality of sub repeaters having a plurality of prestored libraries and a terminal; transmitting command data to at least one of the plurality of linked sub repeaters; and performing control so that the sub repeater receiving the command data automatically transmits a control signal for activating the library included in the command data, wherein the command data includes at least one of a sub repeater serial number, a library serial number, and setting information.

Further, the linking to the plurality of sub repeaters includes at least one of assigning a sub repeater serial number to each of the plurality of linked sub repeaters, and acquiring a sub repeater serial number prestored for each of the plurality of linked sub repeaters.

Further, the linking to the terminal includes acquiring a plurality of libraries in which at least one emission pattern setting value is set from the linked terminal, and extracting a library serial number matched with the acquired plurality of libraries.

Further, the emission pattern setting value is data defining an emission form in which the light emitting device operates, and includes a setting value for at least one of an emission mode, an emission color, an emission time, luminous brightness, and an emission effect.

Further, the transmitting of the command data includes at least one of: determining a first sub repeater based on the sub repeater serial number, determining a first library to be transmitted from the first sub repeater based on the library serial number, and setting first setting information including at least one of a signal radius, a propagation direction, and a reproduction mode of the control signal.

Further, the method for automatically transmitting a control signal based on a plurality of sub repeaters further includes: providing a theme production service to at least one light emitting device operating according to the first library in response to the transmitted control signal, wherein the providing of the theme production service includes performing control so that the first sub repeater transmits a control signal for causing light to be emitted according to the first library prestored in the first sub repeater to at least one light emitting device located within a first signal radius according to the set first setting information, and the light emitting device emits light according to an emission pattern setting value included in the first library transmitted through the control signal.

Further, the method for automatically transmitting a control signal based on a plurality of sub repeaters further includes: acquiring a scenario in which a library reproduction order is set for each sub repeater in advance; and monitoring in real time the library transmitted through the control signal by at least one sub repeater based on the acquired scenario.

Further, the monitoring of the library transmitted through the control signal by the sub repeater in real time further includes detecting a first sub repeater transmitting a library not matched with the acquired scenario; and adjusting the control signal transmitted to the first sub repeater so that the first sub repeater transmits a normal library preset for the acquired scenario.

Meanwhile, a control signal automatic transmission system based on a plurality of sub repeaters includes a main repeater linked to a plurality of sub repeaters and including a control unit configured to remotely control the plurality of sub repeaters, wherein the control unit is linked to a plurality of sub repeaters having a plurality of prestored libraries and a terminal, transmits command data to at least one of the plurality of linked sub repeaters, and controls the sub repeater receiving the command data so that the sub repeater automatically transmits a control signal for activating a library included in the command data, and the command data includes at least one of a sub repeater serial number, a library serial number, and setting information.

In the automatic control signal transmission system based on a plurality of sub repeaters according to an embodiment of the present disclosure, when the main repeater transmits the command data for controlling the plurality of sub repeaters disposed at the plurality of places, each sub repeater automatically transmits the predetermined control signal according to the transmitted command data to a light emitting device within a preset distance, thereby eliminating spatial constraints in production using the light emitting devices, reducing waste of a time/procedure required for setting for controlling the light emitting devices, and increasing audience's satisfaction with an event experience due to utilization in a space for experience or the like.

Further, the automatic control signal transmission system based on a plurality of sub repeaters according to an embodiment of the present disclosure escapes an existing operating system that requires direct control performed by an operator, thereby reducing human resources and increasing economic efficiency due to no need for training on repeater control and no need to operate the repeater each time a production is needed.

Further, the automatic control signal transmission system based on a plurality of sub repeaters according to an embodiment of the present disclosure supports a constant/repeated/regular event production form, thereby easily providing a new experience to a large number of people who experience the space for experience without designing a complex production.

However, the effects of the present disclosure are not limited to the effects mentioned above, and other effects not mentioned may be clearly understood from the description below.

### BRIEF DESCRIPTION OF THE DRAWINGS

FIG. 1 is a conceptual diagram of a theme production service providing system according to an embodiment of the present disclosure.

FIG. 2 is an internal block diagram of a terminal according to an embodiment of the present disclosure.

FIG. 3 is an internal block diagram of a repeater according to an embodiment of the present disclosure.

FIG. 4 is an internal block diagram of a light emitting device according to an embodiment of the present disclosure.

FIG. 5 is a flowchart showing a method for automatically transmitting a control signal based on a plurality of sub repeaters according to an embodiment of the present disclosure.

FIG. 6 is an illustrative diagram illustrating a library and a scenario according to an embodiment of the present disclosure.

FIG. 7 is an illustrative diagram illustrating data of a movement path in which the repeater is installed according to an embodiment of the present disclosure.

FIG. 8 is an illustrative diagram illustrating a state in which a mobile device having a repeater installed therein moves along a course according to an embodiment of the present invention.

FIGS. 9 and 10 are illustrative diagrams illustrating a light emitting process in an overlapping zone of the light emitting device according to an embodiment of the present disclosure.

### DETAILED DESCRIPTION

The present disclosure may be subjected to various transformations and may have various embodiments, and specific embodiments will be illustrated in the drawings and described in detail in the detailed description. The effects and characteristics of the present disclosure and methods for achieving these will become clear from embodiments that will be described in detail later together with the drawings. However, the present disclosure is not limited to the embodiments disclosed below, and can be implemented in various forms. In the following embodiments, terms such as first and second are used for the purpose of distinguishing one component from another component, rather than in a limiting sense. Further, singular expressions include plural expressions unless the context clearly indicates otherwise. In addition, terms such as include or have mean presence of characteristics or components described in the specification, and do not preclude a likelihood of one or more other characteristics or components being added. Further, in the drawings, sizes of the components may be exaggerated or reduced for the convenience of description. For example, since sizes and thicknesses of the respective components shown in the drawings are arbitrarily shown for the convenience of description, the present disclosure is not necessarily limited to what is shown.

Hereinafter, embodiments of the present disclosure will be described in detail with reference to the accompanying drawings, the same or corresponding components are denoted by the same drawing reference signs upon description with reference to the drawings, and redundant descriptions thereof will be omitted.

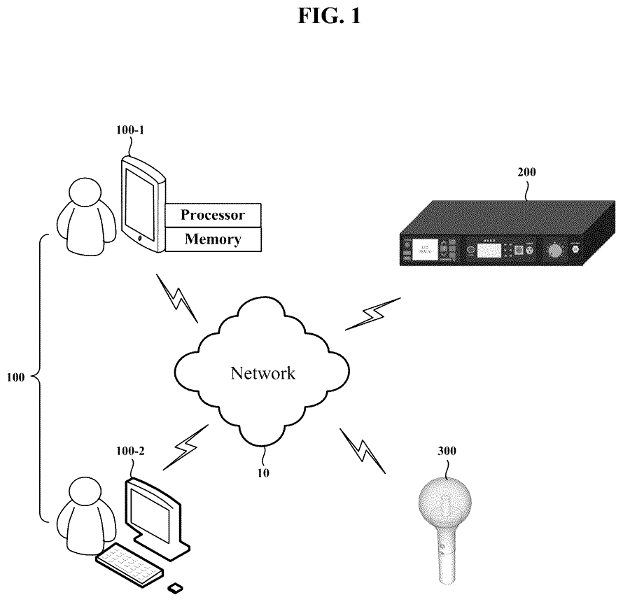

FIG. 1 is a conceptual diagram of theme production service providing system according to an embodiment of the present disclosure.

Referring to FIG. 1, a theme production service providing system (hereinafter, “service providing system”) according to an embodiment of the present disclosure may provide a theme production service of automatically reproducing a predetermined pattern received by a light emitting device by setting a repeater to automatically transmit a control signal for performing control so that the light emitting device emits light in the predetermined pattern (hereinafter, “theme production service”).

In the embodiment, a user may include an administrator who manages and provides the theme production service and/or an audience (or user) who receives a predetermined production event through the theme production service.

In the embodiment, a service providing system implementing theme production service as described above may be connected through a terminal 100, a repeater 200, a light emitting device 300, and a network 10.

Here, the network 10 according to the embodiment means a connection structure in which information may be exchanged between respective nodes, such as the terminal 100, the repeater 200, and/or the light emitting device 300, and examples of the network 10 include a 3rd generation partnership project network (3GPP), a long term evolution (LTE) network, a world interoperability for microwave access network (WIMAX), the Internet, a local area network (LAN), a wireless local area network (wireless LAN), a wide area network (WAN), a personal area network (PAN), a Bluetooth network, a satellite broadcasting network, an analog broadcasting network, a digital multimedia broadcasting (DMB) network, RF, IR, NFC, RFID, and the like, but are not limited thereto.

Hereinafter, the terminal 100, the repeater 200, and/or the light emitting device 300 that implements the service providing system will be described in detail with reference to the accompanying drawings.

### Terminal 100

The terminal 100 according to the embodiment of the present disclosure may be a predetermined computing device in which an automatic transmission program 111 providing theme production service is installed.

Specifically, from a hardware perspective, the terminal 100 may include a mobile computing device 100-1 and/or a desktop type computing device 100-2 in which the automatic transmission program 111 is installed.

Here, the mobile computing device 100-1 may be a mobile device such as a smart phone or tablet PC in which an application including the automatic transmission program 111 is installed.

Examples of the mobile computing device 100-1 may include a smart phone, a mobile phone, a digital broadcasting device, a personal digital assistant (PDA), a portable multimedia player (PMP), a tablet PC, and the like.

Further, the desktop type computing device 100-2 may include a device in which a program for executing theme production service based on wired/wireless communication is installed, such as a personal computer such as a fixed desktop PC, a laptop computer, an ultrabook, or the like in which the automatic transmission program 111 is installed. Further, according to an embodiment, the terminal 100 may further include a predetermined server computing device that provides a theme production service environment.

Specifically, in the present disclosure, the terminal 100 may be a large-capacity fixed server, but is not particularly limited to any one form since the terminal 100 may also be a lightweight mobile server such as a smartphone or tablet. For convenience of description, a case in which the terminal 100 is implemented as the desktop type computing device 100-2 will be described.

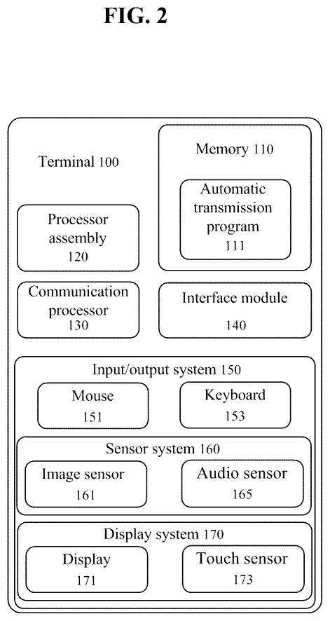

FIG. 2 is an internal block diagram of a terminal according to an embodiment of the present disclosure.

Referring to FIG. 2, from a functional perspective, the terminal 100 may include a memory 110, a processor assembly 120, a communication processor 130, the interface module 140, an input/output system 150, a sensor system 160, and a display system 170. These components may be configured to be included in a housing of the terminal 100.

Specifically, the memory 110 stores the automatic transmission program 111, and the automatic transmission program 111 may store one or more of various application programs, data, and commands for providing the theme production service environment.

That is, the memory 110 may store commands and data that may be used to create the theme production service environment.

Further, the memory 110 may include a program area and a data area.

Here, the program area according to the embodiment may be linked between an operating system (OS) that boots the terminal 100 and functional elements, and data generated according to the use of the terminal 100 may be stored in the data area.

Further, the memory 110 may include at least one non-transitory computer-readable storage medium and a temporary computer-readable storage medium.

For example, the memory 110 may be various storage devices such as a ROM, an EPROM, a flash drive, and a hard drive, and may include a web storage that performs a storage function of the memory 110 on the Internet.

The processor assembly 120 may include at least one processor that can execute commands of the automatic transmission program 111 stored in the memory 110 to perform various tasks for creating the theme production service environment.

In an embodiment, the processor assembly 120 may control an overall operation of the components through the automatic transmission program 111 of the memory 110 in order to provide the theme production service.

This processor assembly 120 may be a system on chip (SOC) suitable for the terminal 100 including a central processing unit (CPU) and/or a graphic processing unit (GPU), may execute an operating system (OS) and/or an application program stored in the memory 110, and may control each component of the terminal 100.

Further, the processor assembly 120 may perform communication with each component internally through a system bus, and may include one or more predetermined bus structures including a local bus.

Further, the processor assembly 120 may be implemented to include at least one of application specific integrated circuits (ASICs), digital signal processors (DSPs), digital signal processing devices (DSPDs), programmable logic devices (PLDs), field programmable gate arrays (FPGAs), controllers, micro-controllers, microprocessors, and other electrical units for performing functions.

The communication processor 130 may include one or more devices for communication with an external device. The communication processor 130 may perform communication via a wireless network.

Specifically, the communication processor 130 may communicate with the terminal 100 that stores a content source for implementing the theme production service environment, and may communicate with various user input components such as a controller that receives a user input.

In an embodiment, the communication processor 130 may transmit or receive various types of data related to a theme production service to or from another terminal 100, an external server, and/or the like.

This communication processor 130 can wirelessly transmit or receive data to or from at least one of a base station, an external terminal, and an arbitrary server on a mobile communication network constructed through a communication device capable of performing technical standards or communication schemes (for example, long term evolution (LTE), long term evolution-advanced (LTE-A), 5G New Radio (NR), and WIFI) for mobile communication, a short-range communication scheme (for example, NFC or RFID), wireless communication methods (for example, RF or IR), and/or the like.

The interface module 140 may communicatively connect the terminal 100 to one or more other devices. Specifically, the interface module 140 may include a wired and/or wireless communication device that is compatible with one or more different communication protocols.

Through this interface module 140, the terminal 100 may be connected to various input/output devices.

For example, the interface module 140 may be connected to an audio output device such as a headset port or a speaker to output audio.

For example, the audio output device has been described as being connected through the interface module 140, but an embodiment in which the audio output device is installed inside the terminal 100 may also be included.

Further, for example, the interface module 140 may be connected to an input device such as a keyboard and/or a mouse to acquire an user input.

This interface module 140 may include at least one of a wired/wireless headset port, an external charger port, a wired/wireless data port, a memory card port, a port for connecting a device including an identification module, an audio input/output (I/O) port, a video input/output (I/O) port, an earphone port, a power amplifier, an RF circuit, a transceiver, and other communication circuits.

The input/output system 150 may detect a user input related to the theme production service (for example, a gesture, a voice command, an operation of a button, or another type of input).

To this end, the input/output system 150 may include the sensor system 160 and the display system 170.

Specifically, the input/output system 150 may include a predetermined button, a touch sensor, and/or an image sensor that receives a user motion input.

Further, the input/output system 150 may be connected to an external controller through the interface module 140 to receive a user input.

Further, the input/output system 150 may receive a user input (for example, a touch input, a mouse input, a keyboard input, a gesture input, a motion input using a guide tool).

For example, the input/output system 150 in the terminal 100 may be connected to at least one device such as a mouse 151, a keyboard 153, a gesture input controller, an image sensor (for example, a camera), and an audio sensor through various communication protocols to acquire a user input.

Further, the terminal 100 may be connected to an external output device through the input/output system 150, and may be connected to, for example, the display system 170 and an audio output device to output predetermined data.

The sensor system 160 may include various sensors such as an image sensor 161, a position sensor (IMU) 163, an audio sensor 165, a distance sensor, a proximity sensor, and a contact sensor.

Here, the image sensor 161 may capture images and/or videos of a physical space around the terminal 100.

In an embodiment, the image sensor 161 may capture and acquire various images and/or videos related to the theme production service.

Further, the image sensor 161 may be disposed on a front surface or/and a back surface of the terminal 100 and film a disposition direction side to capture a video, and a physical space may be filmed through a camera disposed toward the outside of the terminal 100.

The image sensor 161 may include an image sensor device and an image processing module. Specifically, the image sensor 161 may process still images or moving images obtained by an image sensor device (for example, a CMOS or a CCD).

Further, the image sensor 161 may process the still images or moving images acquired by the image sensor device using an image recognition process (for example, OCR) and/or an image processing module to extract necessary information, and transmit the extracted information to the processor.

The image sensor 161 may be a camera assembly including at least one camera. The camera assembly may include a general camera that films a visible light band, and may further include a special camera such as an infrared camera or a stereo camera.

Further, the image sensor 161 as described above may be included in the terminal 100 and operated according to an embodiment, or may be included in an external device (for example, the external server) and operated through linkage based on the communication processor 130 and/or interface module 140 described above.

The audio sensor 165 may recognize sounds around the terminal 100.

Specifically, the audio sensor 165 may include a microphone capable of detecting a voice input of a user who uses the terminal 100.

In an embodiment, the audio sensor 165 may receive voice data required for the theme production service from the user.

The display system 170 may output various types of information related to the theme production service as graphic images.

In an embodiment, the display system 170 may display various user interfaces (for example, a library setting interface) for the theme production service.

Such a display may include at least one of a liquid crystal display (LCD), a thin film transistor-liquid crystal display (TFT LCD), an organic light emitting diode (OLED), a flexible display, a 3D display, and an e-ink display.

The components may be disposed within the housing of such the terminal 100, and the user interface may include a touch sensor 173 on a display 171 configured to receive a user touch input.

Specifically, the display system 170 may include a display 171 that outputs an image and a touch sensor 173 that detects a user's touch input.

For example, the display 171 may be implemented as a touch screen by forming a mutual layer structure with a touch sensor 173 or being formed integrally with the touch sensor 173. This touch screen can function as a user input unit that provides an input interface between the terminal 100 and the user, and provide an output interface between the terminal 100 and the user.

The terminal 100 including the above-described components may store at least one library, scenario, emission pattern setting value, setting information, and/or movement path data in the memory 110 according to an embodiment.

Further, in the embodiment, the terminal 100 may acquire and store at least one library from the external server based on the automatic transmission program 111.

Further, in the embodiment, the terminal 100 may set a library to be transmitted through a control signal from a repeater disposed in a mobile device based on the library setting interface.

Here, the mobile device according to the embodiment may mean a device that is utilized at a predetermined event site (for example, a parade and/or march) and moves while carrying people, structures, repeaters, and the like.

That is, in the embodiment, the terminal 100 may store a plurality of libraries including various emission patterns produced based on the library setting interface. In this case, when the plurality of stored libraries are combined, one scenario may be formed, and when a plurality of scenarios are combined, one theme may be formed.

In the above description, a case where the terminal 100 according to the embodiment of the present disclosure performs the functional operation as described above has been described, but depending on the embodiment, at least some of the functional operations performed by the terminal 100 may be performed by an external device (for example, a service providing server), and at least some of the functional operations performed by the external device may be further performed by the terminal 100 and/or the repeater 200, and thus, various embodiments are possible.

### Repeater 200

The repeater 200 according to the embodiment of the present disclosure may be a computing device that receives a control signal from the automatic transmission program 111 that provides the theme production service and transmits the received control signal to the light emitting device 300.

Specifically, in the embodiment, the repeater 200 may communicate with the communication processor 130 of the terminal 100 through a wired or wireless network to acquire a control signal including at least one library, and transmit the acquired control signal.

In one embodiment, the repeater 200 may be a device that is installed in a predetermined mobile device and transmits a predetermined control signal to at least one light emitting device detected within a preset range while moving as mobile device moves.

Such a repeater 200 may further include a predetermined detection sensor (for example, an infrared sensor) to detect an audience (hereinafter, a user) who has entered a preset range.

In an embodiment, the repeater 200 may include a repeater terminal, an antenna, and/or a distance adjustor.

The repeater terminal and the antenna may have a 1:1 and/or 1:n relationship. In this case, the antenna may be a directional antenna.

The repeater terminal and the antenna may be installed in the mobile device (for example, a parade car), and in this case, the antenna may be installed in an outward direction from the mobile device.

Further, the repeater terminal may include an LCD display. In this case, the LCD display may display predetermined information downloaded for provision of theme production service.

The distance adjustor may be a switch-type and/or dial-type attenuator. Further, the distance adjustor may be of an external type. Further, the distance adjustor may allow a dial and/or a minimum distance to be adjusted. For example, the administrator may adjust a dial of the repeater in units of 5 dBm based on the distance adjustor. In this case, the administrator may adjust a distance of the signal range in units of meters (m). Here, a minimum distance of the signal range may be 20 m.

Further, in the embodiment, the repeater 200 may further include a custom case that may be manufactured according to an installation environment of a client.

This repeater 200 has the advantage of being able to easily control a plurality of light emitting devices without individual pairing, since the repeater 200 may transmit the control signal without having to individually detect the positions of light emitting devices simply by installing the repeater in a predetermined place.

Further, in the embodiment, the repeater 200 may transmit a predetermined control signal to at least one light emitting device detected within a preset range according to setting information.

The setting information in the embodiment may include a signal radius, a propagation direction, and at least one library and/or scenario to be included in a control signal. This setting information may be preset by a theme production service administrator (hereinafter, a “administrator”), and details of the setting information will be described later.

To this end, the terminal 100 and/or the repeater 200 may generate and set setting information to be applied to the repeater 200.

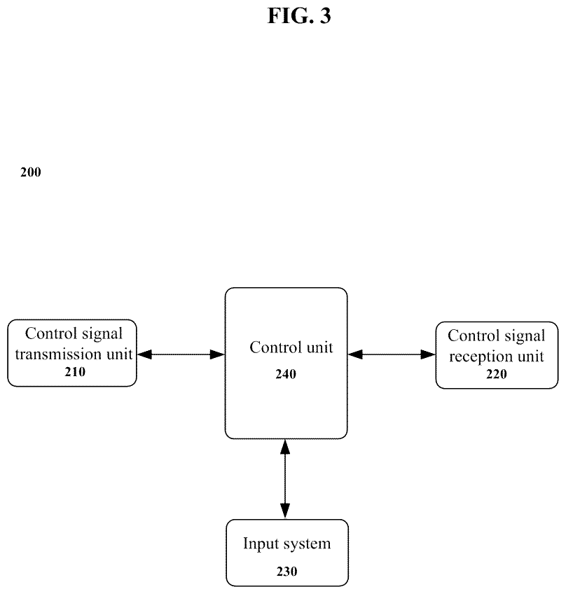

FIG. 3 is an internal block diagram of the repeater according to an embodiment of the present disclosure.

Referring to FIG. 3, the repeater 200 may include a control signal transmission unit 210, a control signal reception unit 220, an input system 230, and a control unit 240. These components may be configured to be included in the housing of the repeater 200.

Specifically, the control signal transmission unit 210 may include one or more devices for communication with the terminal 100.

Further, the control signal transmission unit 210 may communicate with other terminals to implement an environment for control signal communication.

In the embodiment, the control signal transmission unit 210 may transmit or receive various types of data related to control signal communication to or from another terminal, an external server, and/or the like.

This control signal transmission unit 210 may wirelessly transmit or receive data to or from at least one of a base station, an external terminal, an arbitrary server, and an antenna on a mobile communication network constructed through a communication device capable of performing technical standards or communication schemes (for example, long term evolution (LTE), long term evolution-advanced (LTE-A), 5G New Radio (NR), and WIFI) for mobile communication, a short-range communication scheme, and/or the like.

Further, in the embodiment, the control signal transmission unit 210 may transmit information based on a short-range communication scheme.

To this end, in the embodiment, the control signal transmission unit 210 may include a wireless communication module for short-range communication (for example, at least one of NFC, RF transmitter/receiver, Zigbee, Bluetooth, and WiFi modules).

Further, in the embodiment, the control signal transmission unit 210 may transmit the control signal received from the terminal 100 to at least another device (in the embodiment, the light emitting device 300) in a one-to-many manner.

For example, the control signal transmission unit 210 may transmit the control signal to at least one light emitting device 300 in a broadcasting manner (an all-to-all communication scheme for transmitting traffic to an unspecified number of people without designating recipients).

Specifically, the control signal transmission unit 210 may transmit the control signal to the light emitting devices located in the vicinity with a preset broadcasting protocol, the light emitting devices set to receive a broadcast signal of the preset broadcasting protocol located in a short range may receive the transmitted control signal, and the light emitting devices may operate according to the received control signal.

In this case, the preset broadcasting protocol may mean a frequency band, a control signal encoding/decoding scheme, and the like. The control signal transmission unit 210 may include a broadcasting transmitter. Further, the broadcasting transmitter may include an exciter configured of an oscillator and a modulator, modulate a control signal received from the terminal 100 into radio waves in a frequency band defined according to a preset broadcasting protocol, and transmit an RF signal through an antenna.

The control signal transmission unit 210 can overcome problems of low transmission speed, short transmission distance, small data capacity transmission, excessive power consumption, and the like, which are disadvantages of Bluetooth (BLE) technology, by using a broadcasting scheme, easily control a plurality of light emitting devices, save a time required for pairing that the user must perform separately for each light emitting device and the light emitting device control signal repeater 200, and increase the speed of data transmission.

Further, in the embodiment, the control signal transmission unit 210 may continuously transmit (for example, infinitely loop) a control signal for activating a predetermined library when a specific event and/or trigger is acquired.

Further, in the embodiment, the control signal transmission unit 210 may change the library included in the control signal when the specific event and/or trigger is acquired.

For example, the specific event and/or trigger may include detection of a person's approach based on a predetermined sensor, detection of input of a light emitting device, a preset production cycle, and the like.

Meanwhile, the control signal reception unit 220 may receive a control signal from another terminal including the terminal 100 and/or the server.

This control signal reception unit 220 may include one or more devices for communication with the terminal 100 like the control signal transmission unit 210, and description thereof will be omitted since the content thereof is the same.

The input system 230 may detect a user input related to the theme production service (for example, a gesture, a voice command, an operation of a button, or another type of input).

To this end, the input system 230 may include a predetermined button, a controller, a touch sensor, and/or an image sensor that receives a user motion input.

Further, the input system 230 may be connected to an external controller through an interface unit and receive a user input.

Further, the input system 230 may receive a user input (for example, a touch input, a mouse input, a keyboard input, a gesture input, or a motion input using a guide tool).

For example, the repeater 200 may acquire the user input by the input system 230 being connected to at least one device such as a numeric keypad, an IR remote control, or the like by a cable and/or wirelessly through various communication protocols.

In this case, the repeater 200 may include an interface unit (for example, a USB connection port) to acquire a user input through a wired connection.

That is, a type of input to the input system 230 of the repeater 200 may include an input by direct manipulation, a wired input, and/or a wireless input.

For example, the input may be performed based on a series of wired and wireless input devices (for example, a keyboard, a numeric keypad, a mouse, and a remote control) connected to the USB connection port of the repeater 200.

In this case, in the case of a wired input, remote control is possible at a distance corresponding to a length of a cable. Further, a wireless input may be performed based on a remote control linked to IR, RF, NFC, Bluetooth, and/or the repeater 200. In this case, there should be no obstacles in front of the repeater 200 and/or an IR sensor of the remote control.

The control unit 240 may include at least one processor capable of executing commands for transmitting and receiving at least one control signal in order to perform various tasks for creating the theme production service environment.

In the embodiment, the control unit 240 may control the overall operation of the components of the repeater 200 in order to provide the theme production service. In the implementation of the control unit 240, the description described above to the content of the processor assembly 120 of the terminal 100 is applied.

### Light Emitting Device 300

In the embodiment of the present disclosure, the light emitting device 300 may be a predetermined device that emits light according to a control signal including setting values of brightness, saturation, effect, and the like received from the terminal 100 and/or the repeater 200 based on theme production service.

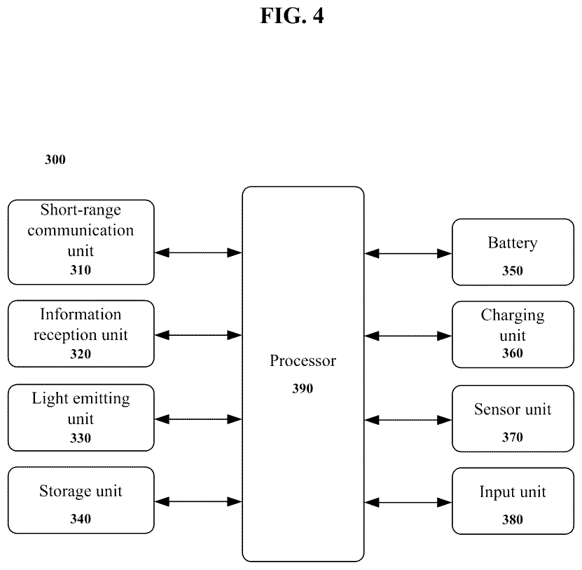

FIG. 4 is an internal block diagram of the light emitting device according to an embodiment of the present disclosure.

Referring to FIG. 4, the light emitting device 300 in the embodiment may include a short-range communication unit 310, an information reception unit 320, a light emitting unit 330, a storage unit 340, a battery 350, a charging unit 360, a sensor unit 370, an input unit 380, and a processor 390.

The short-range communication unit 310 may include one or more devices for communication with an external device. This short-range communication unit 310 may perform communication through a wired or/and wireless network.

In the embodiment, the short-range communication unit 310 may transmit or receive various types of data related to a theme production service to another terminals, an external server, and/or the like.

The short-range communication unit 310 may include a wireless communication module (for example, at least one of NFC, RF transmitter/receiver, Zigbee, Bluetooth, and WIFI modules).

The information reception unit 320 may include a broadcast receiver that receives information transmitted in a broadcasting manner from the repeater 200 and other devices. Specifically, the broadcast receiver may receive radio waves transmitted from the repeater 200 through an antenna, and may acquire a control signal by filtering a control signal in the received radio waves.

Through the above-described scheme, the information reception unit 320 in the embodiment may receive an emission pattern control signal included in a control signal emitted in a broadcasting manner from the repeater 200.

The light emitting unit 330 may perform a function of emitting light according to a control signal received based on the information reception unit 320.

The light emitting unit 330 may include one or more light source elements, and the light source may be, for example, a light emitting diode (LED). Further, the light emitting unit 330 may include LEDs of different colors, and may include, for example, at least one of a red LED, a green LED, a blue LED, and a white LED.

When light emitted from these LEDs is mixed, a wide range of colors may be created, the mixed color is determined based on a ratio of intensities of the light emitted from the respective LEDs, and the intensities of the light emitted from each LED may be proportional to a driving current of each LED.

The plurality of LEDs included in the light emitting unit 330 may be arranged in a dot shape, and selectively turned on under the control of the processor 390 to be described below, so that a specific phrase (text), image, or video can be displayed.

Although an example of the light source of the light emitting unit 330 has been described as an LED, a type of light source is not limited to the LED. According to another embodiment, an organic light emitting diode (OLED) may be used as the light source.

The storage unit 340 may store one or more of various application programs, applications, data, and commands for providing the theme production service environment.

Further, the storage unit 340 may store data received from or generated by other components of an automatic transmission system. The storage unit 340 may be various storage devices such as a ROM, an EPROM, a flash drive, a hard drive, and/or a USB drive, and may include a memory, a cache, and a buffer.

In an embodiment, the storage unit 340 may store information necessary for a light emitting function of the light emitting device 300.

In an embodiment, the storage unit 340 may store at least one library and/or scenario that defines an emission form in which the light emitting device 300 operates. This will be described in detail later.

Further, in the embodiment, the storage unit 340 may store information necessary for performing of the theme production service.

The battery 350 may receive external and/or internal power and supply power necessary for an operation to each component of the light emitting device 300 under the control of the processor 390.

The battery 350 may further include a DC/DC converter that can convert the supplied power into a voltage level that may be used by components of the light emitting device 300.

Further, the battery 350 includes at least one battery cell. A type of each battery cell is not particularly limited as long as the cell is capable of being repeatedly charged and discharged, like a lithium ion cell.

The charging unit 360 may include wired and wireless charging modules for providing wired and wireless charging processes of supplying power necessary for an operation of the light emitting device 300.

The sensor unit 370 may include at least one of a position sensor (IMU), an acceleration sensor, a gyro sensor, a distance sensor, a proximity sensor, a contact sensor, and a light detection sensor.

Specifically, the position sensor (IMU) included in the sensor unit 370 may detect at least one of a movement and acceleration of the light emitting device 300. For example, the position sensor may be formed by a combination of various position sensors such as an accelerometer, a gyroscope, and a magnetometer.

The input unit 380 may detect a user input (for example, a gesture, an operation of a button, or another type of input) related to the theme production service.

Specifically, the input unit 380 may include, for example, a predetermined button and/or a touch sensor.

Further, the input unit 380 may be connected to an external controller and receive a user input.

The processor 390 may perform a data processing function of controlling the overall operation such as power supply control of the light emitting device 300, and a signal flow between the internal configurations of the light emitting device 300, and processes data. The processor 390 may include at least one processor.

Further, the processor 390 may communicate with each component internally through a system bus, and may include one or more predetermined bus structures, including a local bus.

Further, the processor 390 may be implemented to include at least one of application specific integrated circuits (ASICs), digital signal processors (DSPs), digital signal processing devices (DSPDs), programmable logic devices (PLDs), field programmable gate arrays (FPGAs), controllers, micro-controllers, microprocessors, and other electrical units for performing functions.

In the embodiment, the processor 390 may control the emission pattern of light output from the light emitting unit 330 by controlling the driving current of each LED of the light emitting unit 330.

This allows the processor 390 in the embodiment to control the light emission device 300 including a plurality of LEDs and form a predetermined phrase, image, video, and the like.

The light emission device 300 including the above-described configuration may operate according to at least one pieces of data stored in the storage unit 340 under the control of the processor 390.

Accordingly, the automatic transmission system may provide a theme production service for performing an event production in which the emission pattern changes as the mobile device having the repeater installed therein approaches a predetermined area when the light emission device 300 is provided to the audience, who views an event (for example, a parade, a marching band, or opening ceremony) in the predetermined area while holding the provided light emission device 300.

Further, in the embodiment, the light emission device 300 may emit light according to a control signal received from the repeater 200 based on the light emitting unit 330.

In this case, the control signal may include command data for activating the light emitting device 300 so that the light emitting device 300 emits light with a library and/or scenario previously stored in the light emitting device 300.

Further, in the embodiment, the light emitting device 300 may detect movement and acceleration of the light emitting device 300 based on the sensor unit 370.

Further, in the embodiment, the light emitting device 300 may recognize a surrounding sound based on the sensor unit 370 and emit light according to the recognized sound. For example, the louder the recognized sound, the brighter the light may emit light.

Further, in the embodiment, the light emitting device 300 may transmit data detected by the sensor unit 370 and/or the input unit to another device (for example, the terminal 100 and/or the repeater 200).

Further, in the embodiment, the light emitting device 300 may operate passively according to a command signal (control signal) transmitted from the outside. In another embodiment, the light emitting device 300 may operate independently based on the input unit 380 (for example, a predetermined button).

The concept of an operation may vary and is not limited to any one concept. For example, various types of operation such as a light emitting operation, a sound generating operation, and a mechanical operation are possible depending on a type (for example, a lighting stick and/or a wearable device) of light emitting device 300.

### Method for Automatically Transmitting Control Signal Based on Plurality of Sub Repeaters

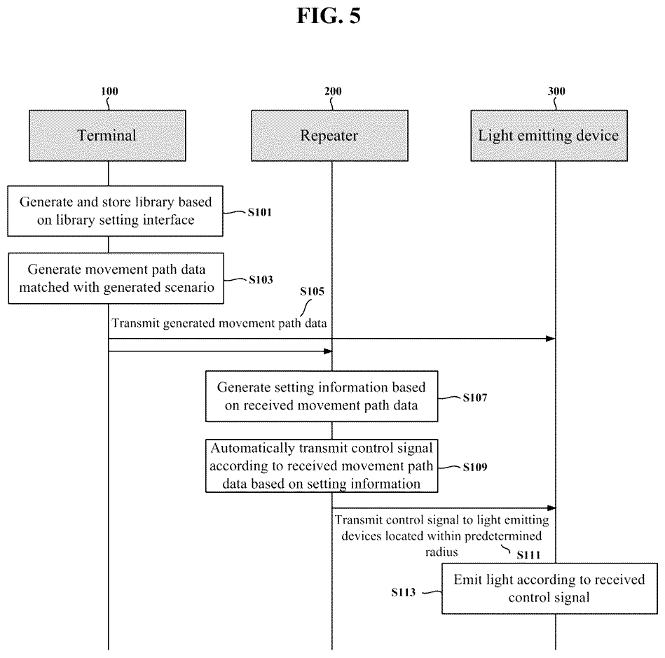

Hereinafter, a method for automatically transmitting a control signal based on a plurality of sub repeaters to provide the theme production service in the control unit 240 executed by at least one processor of the repeater 200 according to an embodiment of the present disclosure will be described in detail with reference to the accompanying FIGS. 5 to 10.

Meanwhile, in order to allow the repeater 200 to perform the method of automatically transmitting a control signal based on a plurality of sub repeaters based on the control unit 240, at least one processor of the terminal 100 in the embodiment of the present disclosure may execute at least one automatic transmission program 111 stored in at least one memory 110 or operate in a background state.

Hereinafter, a case in which the automatic transmission program 111 performs a process in which the at least one processor of the terminal 100 operates to execute commands in the memory 110 and support the repeater 200 described above so that the repeater 200 performs the method of automatically transmitting a control signal based on a plurality of sub repeaters will be briefly described.

Further, a case in which the control unit 240 performs a process in which the at least one processor of the repeater 200 operates to execute commands in the control unit 240 and performs the method of automatically transmitting a control signal based on a plurality of sub repeaters described above will be briefly described.

FIG. 5 is a flowchart showing a method for automatically transmitting a control signal based on a plurality of sub repeaters according to an embodiment of the present disclosure.

Referring to FIG. 5, in the embodiment, the automatic transmission program 111 can create and store a scenario based on the library setting interface (S101)

The library setting interface according to the embodiment may be an interface that provides a creation environment for creating the library that defines the emission form in which the light emitting device 300 operates and/or a scenario that is a combination of a plurality of libraries.

That is, in the embodiment, the automatic transmission program 111 may create a library based on the library setting interface.

Here, the library according to the embodiment is data in which an emission pattern for causing the light emitting device 300 to emit light for a predetermined period of time is set in advance,

Further, the emission pattern means the emission form in which the light emitting device 300 operates according to components including an emission mode (for example, an on mode, an off mode, and a sound recognition mode), emission color, emission time, luminous brightness, and emission effect.

In this case, the luminous effect may mean an emission form in which the components are set to change within a predetermined time and create a dynamic visual effect.

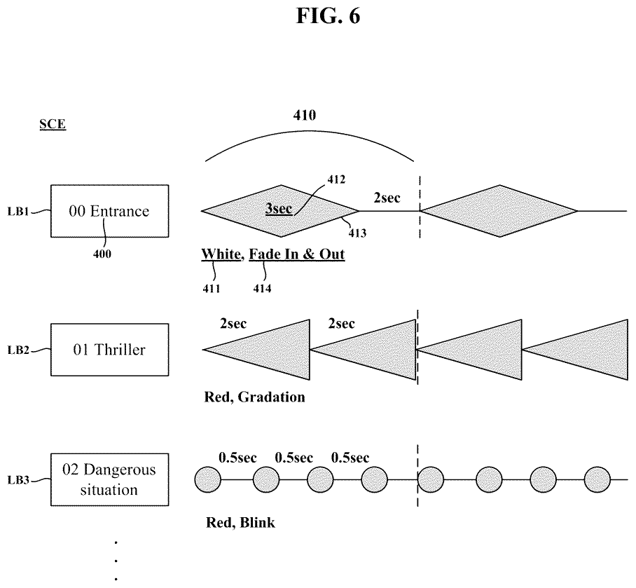

FIG. 6 is an illustrative diagram illustrating a library and a scenario according to an embodiment of the present disclosure.

Referring to FIG. 6, in the embodiment, a scenario SCE may include at least one library LB1, LB2, or LB3.

The scenario SCE may mean one set that is a combination of a plurality of libraries LB having a predetermined luminous pattern in a predetermined order.

Specifically, the scenario SCE may mean library set data that is reproduced while the light emitting device located within a signal radius where a control signal is received, by setting an order, retention time, and the like for a plurality of libraries LB. This scenario may include a predetermined identification number.

Further, one library may include a library name 400 and first to fourth setting values 411, 412, 413, and 414 which are component setting values (hereinafter, luminous pattern setting values) of each luminous pattern.

The library name 400 may include at least one of a specific identification number and/or text.

The first setting value 411 may be data for emission color, the second setting value 412 may be data for an emission time, the third setting value 413 may be data for luminous brightness, and the fourth setting value 414 may be data for an emission effect.

Here, an emission pattern maintained for a predetermined time according to the second setting value 412, which is the data for the emission time, may be referred to as a ‘part 410’. That is, one library may include at least one part. Typically, a predetermined part may be repeatedly reproduced within the library.

The emission pattern setting value may be data in which all colors, times, brightness, and effects that may be implemented by the light emitting device as values or text.

For example, the first setting value 411 may be set as a hexadecimal code (RGB 565 notation) representing RGB color, the second setting value 412 may be set as a value representing the duration in seconds, the third setting value 413 may be set as a brightness value between 0 and 100 where the higher the value, the brighter the brightness, and the fourth setting value 414 may be set as a text representing a predetermined effect.

Specifically, emission color of the light emitting device may be expressed in 65,535 or more colors depending on the first setting value 411.

For example, the first setting value 411 indicating the emission color may be expressed as values of (0, 0, 0), (0, 0, 1), (0, 0, 2) . . . (n, n, n) according to an RGB 565 notation. Further, the third setting value 413 indicating the luminous brightness may be indicated as a value of 0, 1, 2, . . . n, where a greater value indicates a high brightness.

Further, the fourth setting value 414 may include, for example, (1) a blink effect in which the light emitting device is quickly blinked by whether or not to emit light within a predetermined period of time being set differently in each time zone, (2) a gradation effect in which an emission color gradually changes by a color being set differently in each time zone, and (3) a fade in/out effect in which the brightness gradually decreases or brightens by the brightness being set differently in each time zone.

As illustrated in FIG. 6, for example, the first library LB1 may include a library name 400 with an identification number “00” and text “Entry”. The first library LB1 may include a first part 410 having the first to fourth setting values 411, 412, 413, and 414 defined as a state in which ‘the first part 410 is faded in and out in white color for three seconds, and does not emit light for two seconds’. Further, the first part 410 may be repeatedly reproduced within the first library LB1.

That is, in the embodiment, the automatic transmission program 111 may create and store a library by determining at least one emitting pattern setting values included in each library based on the library setting interface.

Further, in the embodiment, the automatic transmission program 111 may create and store a scenario by combining the at least one library created based on the library setting interface.

In the embodiment, the automatic transmission program 111 may store a library and/or scenario directly created based on the automatic transmission program 111, or may acquire and store a library and/or scenario created by an external terminal and/or server. An object transmitted to the repeater and the light emitting device may be a library and/or scenario, but is collectively referred to as the library for the convenience of description hereinafter.

A scenario including at least one library LB1, LB2, or LB3 stored in this way may correspond to a single course (for example, parade course) including a number of divided spaces (hereinafter, sections). Further, each of the number of sections included in the course may correspond to a library. That is, while the audience views the event in a predetermined area included in the course, the light emitting device 300 may change the emission pattern based on a control signal to be acquired, and operate.

The control signal according to the embodiment may include command data for activating (for example, executing, interrupting, or ending) the light emitting device 300 according to the library.

To this end, the light emitting device 300 has a prestored library and/or scenario, and the light emitting device 300 according to the embodiment may perform one of executing, repeating, interrupting, and ending the prestored library and/or scenario according to the acquired control signal.

Further, the automatic transmission program 111 may generate movement path data matched with the generated scenario (S103).

Here, the movement path data according to the embodiment may be data that is set to transmit a control signal for activating different libraries in each area as the mobile device having the repeater installed therein moves along the course including the plurality of areas.

Such movement path data may include a scenario including at least one library, at least one area (space) matched with each library, and/or required time information.

To this end, the automatic transmission program 111 according to the embodiment may acquire map data for a course that the mobile device having the repeater installed therein will actually use. In this case, the map data may include a map image and/or a map interface obtained by visualizing the course that the mobile device will use.

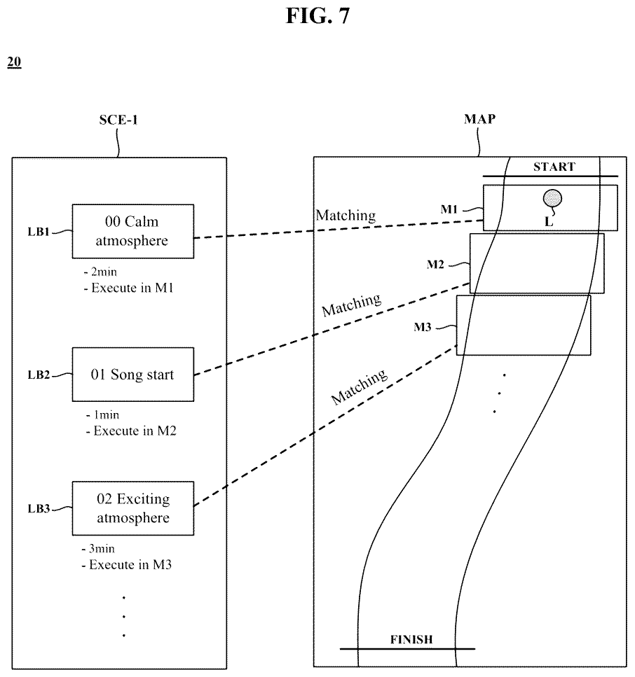

FIG. 7 is an illustrative diagram illustrating movement path data according to an embodiment of the present invention.

Referring to FIG. 7, in the embodiment, the automatic transmission program 111 can acquire a first scenario SCE-1 in which at least one library LB1, LB2, and LB3 is aligned in a predetermined order.

In addition, in the embodiment, the automatic transmission program 111 may set at least one divided area M1, M2, and M3 to which different libraries are to be transmitted in map data (MAP) based on a predetermined input.

For example, the administrator may set an area through an input for performing a drag and drop on the map data (MAP). That is, in the embodiment, the automatic transmission program 111 may acquire the map data (MAP) for the course including the plurality of areas.

In this case, in the embodiment, the automatic transmission program 111 may match at least one library LB1, LB2, and LB3 included in the first scenario SCE-1 with the respective areas M1, M2, and M3 in order.

In the illustrated example, the first area M1 may be matched with the first library LB1, the second area M2 may be matched with the second library LB2, and the third area M3 may be matched with the third library LB3.

In addition, in the embodiment, the automatic transmission program 111 may store the movement path data when the matching of the areas to the libraries included in the scenario is completed.

Accordingly, in the embodiment, the automatic transmission program 111 may generate movement path data 20 that is set to transmit a control signal including command data for activating the library matched with a predetermined area when the mobile device is located in the predetermined area on the course.

Here, in order to determine which area the mobile device is located in on the course, the mobile device according to the embodiment may include a GPS.

The GPS installed in the mobile device may transmit position information to the terminal 100 in real time, and the terminal 100 may detect the area to which the mobile device belongs based on the transmitted position information, and set the repeater 200 to automatically transmit a control signal for activating the library matched with the area.

In addition, position information L may be displayed in real time on the map data MAP.

That is, in the embodiment, the movement path data may mean data in which the area is matched with each library included in the scenario.

In another embodiment, the automatic transmission program 111 may measure a time required to pass through each area in advance and preset a required time in the area. Then, a control signal for activating the library for the required time that has been preset in each area may be transmitted.

For example, a first required time information T1 may be set in the first library LB1, a second required time information T2 may be set in the second library LB2, and a third required time information T3 may be set in the third library LB3.

That is, in another embodiment, the movement path data may mean data in which required time information is set in each library included in the scenario.

In addition, in the embodiment, the automatic transmission program 111 may transmit the generated movement path data to the repeater 200 and the light emitting device 300 (S105).

Specifically, in the embodiment, the automatic transmission program 111 may transmit the generated movement path data to the repeater 200, and may transmit the scenario included in the generated movement path data to the light emitting device 300.

To this end, in the embodiment, the automatic transmission program 111 may store movement path data including the generated library in an SD card and/or a removable drive.

Accordingly, in the embodiment, the administrator may connect the SD card and/or the removable drive to the repeater 200 and transmit and store the movement path data to and in the repeater 200.

In this case, an LCD window of the repeater according to the embodiment may display the scenario identification number and at least one library name included in the scenario.

In addition, the terminal 100 may be linked to the light emitting device 300 and the library may also be transmitted to and stored in the plurality of light emitting devices 300.

In this case, the light emitting device 300 according to the embodiment may store, in advance, its own process of increasing the brightness of the library being reproduced by a predetermined ratio when a surrounding light level falls below a preset reference level based on a light detection sensor.

Further, in the embodiment, the control unit 240 of the repeater 200 may generate setting information based on the received movement path data (S107)

In the embodiment, the setting information may include the signal radius, the propagation direction, and a reproduction mode.

The signal radius may mean a range that the control signal reaches. The propagation direction may mean a propagation direction of a directional antenna having a property that an intensity of electromagnetic waves changes depending on a direction. The reproduction mode has a set reproduction scheme of the library to be reproduced, and may be at least one of one-time reproduction, constant reproduction, and repeated reproduction.

In this case, since the repeater 200 is disposed in the mobile device, the signal radius does not change, but the terminal devices located within the signal radius may change as the repeater 200 moves together with the mobile device.

That is, in the embodiment, the control unit 240 may generate the setting information in which the signal radius, the propagation direction, and/or the reproduction mode for transmitting a control signal based on the scenario included in the received movement path data are set.

For example, the signal radius may be set in units of meters m, such as 25 m, and the propagation direction may be set to be the same as a direction of movement of the course of the mobile device.

The administrator according to the embodiment may confirm the information displayed on the LCD window of the repeater 200 and operate the repeater 200 using the input system 230 to input the generated setting information. For example, the administrator may perform an input based on a controller, buttons, and the like. of the repeater 200 to determine the signal radius, the reproduction mode, and the like.

Meanwhile, a plurality of repeaters 200 may be disposed in one mobile device.

Accordingly, the light emitting devices 300 located within the first signal radius set in the first repeater arranged in the first mobile device may emit light according to a library activation command data included in the control signal transmitted from the corresponding area by the first repeater. In addition, the light emitting devices 300 located within the second signal radius set in the second repeater disposed in the first mobile device may emit light according to a library activation command data included in the control signal transmitted from the corresponding area by the second repeater.

That is, even when the light emitting devices 300 are adjacent to the first mobile device, the libraries to be activated may be different depending on which of the first and second repeaters the light emitting devices are adjacent to.

When the setting information input is completed for each repeater in this way, the administrator according to the embodiment may dispose each repeater in the mobile device and control the mobile device so that the mobile device moves along the course.

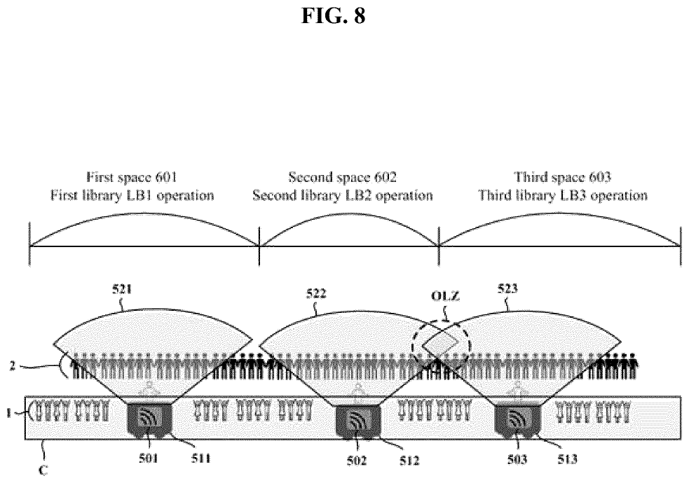

FIG. 8 is an illustrative diagram illustrating a state in which a mobile device with a repeater installed therein moves along a course according to an embodiment of the present invention.

Referring to FIG. 8, first to third repeaters 501, 502, and 503 may be installed in the first to third mobile devices 511, 512, and 513 according to the embodiment.

In this case, a predetermined event group 1 is present within a course C in which the first to third mobile devices 511, 512, and 513 are located, and an audience group 2 affected by the first to third repeaters 501, 502, and 503 installed in the first to third mobile devices 511, 512, and 513 may be present at a predetermined distance from the event group 1. In this case, each audience included in the audience group 2 may carry the light emitting device 300 provided in advance.

In the embodiment, the control unit 240 may perform a setting so that the first repeater 501 transmits a control signal as much as a first signal radius 521 based on the setting information. The control unit 240 may perform a setting so that the second repeater 502 transmits a control signal as much as a second signal radius 522, and the third repeater 503 transmits a control signal as much as a third signal radius 523. In addition, the signal radii may also be different from each other due to different setting information for each repeater.

In this case, the plurality of light emitting devices 300 held by the audience located within the first signal radius 521 may operate according to the control signal of the first repeater.

Further, in the embodiment, the control unit 240 may automatically transmit the control signal including the library based on the setting information (S109)

Specifically, in the embodiment, the control unit 240 may automatically transmit the control signal including the library to at least one light emitting device 300 located within the signal radius according to the signal radius included in the setting information. In this case, in the embodiment, the control unit 240 may transmit the control signal in a broadcasting manner.

In the embodiment, when the installation of the repeater for each mobile device is completed, the administrator may initiate automatic control signal transmission by performing a predetermined input based on the input system 230 of each repeater 200.

Referring back to FIG. 8, as the first to third mobile devices 511, 512, and 513 move, an area to which each mobile device belongs is changed. For example, as shown, when the first mobile device 511 is within a first area 601, a control signal may be transmitted to the first repeater 511 installed in the first mobile device 511 to activate the first library matched with the first area 601.

Then, when the first mobile device 511 moves to a second area 602, a control signal may be transmitted to the first repeater 511 installed in the first mobile device 511 to activate the second library matched with the second area 602.

Thus, the control unit (240) in the embodiment may transmit a library matched with each area that is changed as the mobile device moves.

In this case, when the first to third mobile devices 501, 502, and 503 are adjacent to each other while moving, the signal radii 521, 522, and 523 overlap, and the light emitting devices 300 that receive a plurality of control signals may be generated. In this case, the area where the signal radii overlap may be referred to as an overlapping zone OLZ.

At least one light emitting device 300 located in the overlapping zone OLZ may operate through its own process. Details on this will be described later.

Further, in the embodiment, the control unit 240 may group at least one light emitting device 300 detected within a predetermined time. For example, the control unit 240 may group a plurality of light emitting devices 300 included within a signal radius of the first area within three seconds.

In addition, in the embodiment, the control unit 240 may simultaneously transmit a control signal to a plurality of grouped light emitting devices 300.

That is, in the embodiment, the control unit 240 may transmit the control signal to the light emitting devices 300 located within a predetermined radius (S111)

Accordingly, the light emitting devices 300 set to receive the control signal of the preset broadcasting protocol may receive the transmitted control signal.

Further, in the embodiment, the light emitting device 300 may emit light according to the received control signal (S113)

Specifically, in the embodiment, the light emitting device 300 may operate the library and emit light according to the control signal including the control command for activating the previously stored library.

Here, when the light emitting devices 300 are grouped, the grouped light emitting devices 300 may emit light simultaneously according to the control signal received at the same time.

Meanwhile, in the embodiment, the light emitting device 300 may emit light through its own process based on the library being reproduced, at the time of entrance to the overlapping zone.

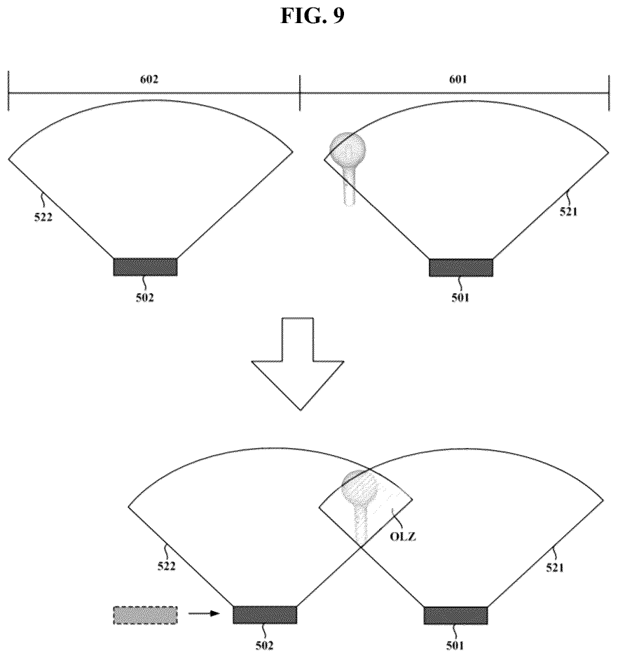

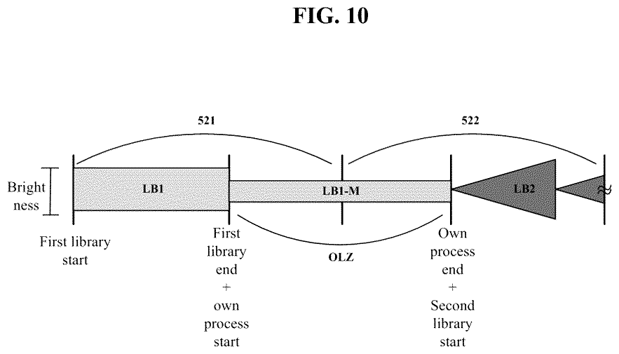

FIGS. 9 and 10 are illustrative diagrams illustrating a light emitting process in the overlapping zone of the light emitting device according to the embodiment of the present disclosure.

Referring to FIG. 9, in the embodiment, the light emitting device 300 may operate as the first library in the first area 601 within the signal radius of the first repeater 501, and as the second library in the second area 602 within a signal radius of the second repeater 502.

However, when a second mobile device 512 having the second repeater 502 installed therein is adjacent to the first mobile device 511 having the first repeater 501 installed therein and the overlapping zone OLZ is formed, a signal is not smoothly transmitted to the light emitting device 300 located in the overlapping zone OLZ or signal collision occurs, resulting in incorrect emission.

Accordingly, in the embodiment, when the light emitting device 300 is determined to have entered the overlapping zone OLZ, the light emitting device 300 may execute its own process.

Referring to FIG. 10, the own process may mean a process of adjusting the light emitting pattern setting value of the first library previously reproduced by the previously received control signal and maintaining the light emitting pattern setting value for a predetermined period of time.

For example, the light emitting device 300 may operate according to the first library LB1 according to a control signal in the first signal radius 521, and may be included in the overlapping zone OLZ according to a control signal in the second signal radius 522.

In this case, when the light emitting device 300 is determined to have entered the overlapping zone OLZ, the light emitting device 300 may end the command for activating the first library LB1 operating in the first signal radius 521 and start its own process to emit light.

Here, the adjusted light emitting pattern setting value may be at least one of the first to fourth setting values. For example, the light emitting device 300 may emit light at a slower speed than that of the existing library through adjustment of the second setting value (an emission time value in an embodiment) to a great value by a predetermined ratio, or may emit light at a lower brightness than that of the existing library through adjustment of the third setting value (a brightness value in an embodiment) to a small value by a predetermined ratio.

That is, in the overlapping zone OLZ, a first modified library LB1-M obtained by changing an emission pattern setting value of the first library, which is an existing library, into a predetermined value may be reproduced. To this end, the light emitting device 300 in the embodiment may store the emission pattern setting value set in the immediately previous library. Further, when there are a plurality of acquired control signals, the light emitting device 300 may emit light according to the stored emission pattern setting value of the immediately previous library.

In addition, in the embodiment, the light emitting device 300 may operate as the first modified library LB1-M through the own process, and then enter the second signal radius 522 in which a control signal for activating the second library is acquired. Alternatively, a control signal acquisition mode may be determined again after a predetermined time period to acquire a new control signal.

In this case, the light emitting device 300 may determine that the light emitting device 300 has left the overlapping zone OLZ, end the own process operating in the first modified library LB1-M operating in the second signal radius 522, and operate the second library LB2.

In another embodiment, the light emitting device 300 may emit light based on a control signal with a stronger signal intensity among a plurality of acquired control signals when the light emitting device 300 is located in the overlapping zone OLZ.

Accordingly, in an event in which the mobile devices moves along the course including a plurality of areas, it is possible to reduce errors that may occur in the light emitting devices, such as emission interruption, emission switching, and flickering due to positions of different repeaters being adjacent, and provide smooth performance to the audience, thereby increasing the satisfaction of an event experience.

Meanwhile, in the embodiment, the control unit 240 may change the library transmitted through the control signal according to a predetermined input.

In this case, the predetermined input for changing the library may include a case in which (1) the repeater 200 is located in a specific preset area, (2) a specific preset time is detected, or (3) an input of a specific preset light emitting device 300 is detected.

In an example of the case of (3), the control unit 240 may change the first library into the second library and transmit a control signal for emission according to the first library when detecting the input of the first preset light emitting device while transmitting the control signal to an unspecified number of light emitting devices. To this end, the control unit 240 may store, in advance, command data for switching to the second library when the input of the first light emitting device is detected.

Further, in the embodiment, the control unit 240 may detect a predetermined input for switching to an event mode while transmitting the control signal according to movement path data.

In the embodiment, the control unit 240 may transmit a control signal for operation according to the event library preset in the event mode when the input for switching to the event mode is detected.

Accordingly, the light emitting devices 300 located within a predetermined distance from the repeater 200 may emit light according to an event library preset in the event mode, rather than a previously transmitted library.

In the embodiment, the light emitting device 300 may operate according to a specific emission effect when a predetermined input to the light emitting device 300 is performed while the light emitting device 300 is emitting light according to the event library.

For example, there may be various embodiments, such as an embodiment in which the light emitting device emits light with a sparkling effect when the light emitting device is shaken, and an embodiment in which the light emitting device emits light with a laser effect when a predetermined button included in the light emitting device is pressed.

Further, in the embodiment, the control unit 240 may record a time at which the input for switching to the event mode is detected, as a history. Similarly, a time at which the event mode switching is released may also be recorded.

Accordingly, in the embodiment, the control unit 240 may store an event mode time point including an event start time point and tan event end time point.

The event mode time point stored in this way may be reflected in the movement path data previously stored in the repeater 200.

Then, in the embodiment, the control unit 240 may change the movement path data in which the event mode time point has been reflected into history data, and store the history data.

The history data stored in this way may be used again later. That is, in the embodiment, the control unit 240 may operate according to the movement path data included in the history data and switches to the event mode at the stored event mode time point so that the repeater 200 transmits the event library.

Accordingly, it is possible to easily generate the history data by operating the repeater without having to generate and store new movement path data when a predetermined event is added to existing movement path data and it is necessary to change mode of the light emitting devices, it is possible to greatly reduce a time required for data generation and downloading since the history data can be reused, and it is possible to flexibly cope with a situation in which an event is suddenly added.

Meanwhile, in another embodiment, the repeater 200 in the theme production service providing system may be divided into a main repeater 200-M that communicates with the terminal 100 through a wired or wireless network, and a sub repeater 200-S that receives command data from the main repeater 200-M and operates through a wired or wireless network.

In another embodiment, the main repeater 200-M may be a predetermined computing device in which the automatic transmission program 111 is installed.

Further, in another embodiment, the main repeater 200-M may assign a serial number to each sub repeater 200-S. Alternatively, the repeater serial number prestored in each sub repeater 200-S may be acquired through a network.

In another embodiment, there are a plurality of sub repeaters 200-S, which may operate according to command data received from the main repeater 200-M.

The main repeater 200-M and/or the sub repeaters 200-S may be disposed in an environment in which the main repeater 200-M and/or the sub repeaters 200-S can perform communication via a wired or wireless network, and a type of location at which the main repeater 200-M and/or the sub repeaters 200-S are disposed is not limited. Specifically, the main repeater 200-M and/or the sub repeater 200-S can be fixed and/or mobile repeaters.

In this case, in another embodiment, the sub repeater 200-S may pre-store the libraries generated in the automatic transmission program 111 of the terminal 100.

In another embodiment, the library may mean a unit in which an emission pattern setting value is preset so that light is emitted in a predetermined emission pattern as shown in FIG. 6. The libraries may be combined into a larger unit called a scenario by gathering a plurality of libraries, but in another embodiment, the sub repeater 200-S may pre-store only a plurality of libraries, not the scenario. Further, in another embodiment, the sub repeater 200-S may transmit a control signal for activating a library instructed to be transmitted from the main repeater 200-M among a plurality of prestored libraries.

In another embodiment, the main repeater 200-M may be linked to the plurality of sub repeaters 200-S that have prestored a plurality of libraries and the terminal 100.

In this case, in another embodiment, the main repeater 200-M may acquire a sub repeater serial number from the sub repeater 200-S and acquire a library serial number matched with the plurality of libraries from the terminal 100.

Further, in another embodiment, the main repeater 200-M may transmit command data to at least one of the plurality of sub repeaters 200-S connected through a network.

Here, the command data according to the other embodiment may include a sub repeater serial number, a library serial number, and/or setting information. The setting information may mean a signal radius and/or a propagation direction of a control signal transmitted by the sub repeater 200-S receiving the command data.

For example, the main repeater 200-M may transmit command data “Change the transmitted library to the second library,” to the first sub repeater based on the serial number of the first sub repeater.

In the above example, one command piece of data has been described as being transmitted to one sub repeater, but one command piece of data may be transmitted to the plurality of sub repeaters, and accordingly, the plurality of sub repeaters may transmit a control signal including the library included in the acquired command data. In other words, the main repeater may control the plurality of sub repeaters with one command.

Accordingly, in another embodiment, the sub repeater 200-S that receives the command data from the main repeater 200-M may change the library included in the control signal transmitted according to the received command data.

Further, in another embodiment, the main repeater 200-M may acquire the scenario from the linked terminal 100. In this case, the scenario may mean a predetermined set of data in which a library reproduction order is set for at least one sub repeater.

Further, in another embodiment, the main repeater 200-M may monitor in real time the library transmitted through the control signal by at least one sub repeater 200-S based on the acquired scenario.

In this case, in another embodiment, the main repeater 200-M may detect the sub repeater 200-S that transmits the library that is not matched with the acquired scenario during monitoring.

Further, in another embodiment, the main repeater 200-M may adjust the control signal transmitted to the sub repeater 200-S so that the detected sub repeater 200-S transmits the library (that is, a normal library) matched with the library included in the scenario.

That is, in another embodiment, the service providing system has the effect of solving the inconvenience of having to individually manually set the signal radius and the library to be transmitted for each repeater, and solving the disadvantage of not being able to make real-time correction for repeaters that operate according to prestored manual settings, making it impossible to cope in real time when an issue occurs.

In other words, in another embodiment, the service providing system determines the repeater to be controlled based on the serial number of the sub repeater 200-S, and transmits command data in which the library to be transmitted by the sub repeater 200-S has been set, to control the sub repeater 200-S, so that the sub repeater 200-S only pre-stores the library and changes the library to the library acquired through the command data for transmission, thereby securing a memory space of the sub repeater 200-S, greatly reducing a data transmission and reception amount, and greatly improving the efficiency of service provision when viewed from the overall system.

As described above, the automatic control signal transmission system based on a plurality of sub repeaters according to an embodiment of the present disclosure automatically transmits a signal for controlling a light emitting device according to predetermined set information when the light emitting device is detected within a preset distance from repeaters by disposing the repeaters in a plurality of mobile devices. thereby eliminating spatial constraints in production using the light emitting devices, reducing waste of a time/procedure required for setting for controlling the light emitting devices, and increasing audience's satisfaction with an event experience due to utilization in a space for experience, or the like.

Further, the automatic control signal transmission system based on a plurality of sub repeaters according to an embodiment of the present disclosure escapes an existing operating system that requires direct control performed by an operator, thereby reducing human resources and increasing economic efficiency due to no need for training on repeater control and no need to operate the repeater each time a production is needed.

Further, the automatic control signal transmission system based on a plurality of sub repeaters according to an embodiment of the present disclosure supports a constant/repeated/regular event production form, thereby easily providing a new experience to a large number of people who experience the space for experience without designing a complex production.

The embodiment of the present disclosure described above may be implemented in the form of program instructions that can be executed through various computer components and recorded on a computer-readable recording medium. The computer-readable recording medium may include program instructions, data files, data structures, and the like, alone or in combination. The program instructions recorded on the computer-readable recording medium may be those specially designed and configured for the present disclosure or those known and available to those skilled in the art of computer software. Examples of the computer-readable recording medium include a magnetic medium such as a hard disk, a floppy disk, and a magnetic tape, an optical recording medium such as a CD-ROM and a DVD, a magneto-optical medium such as a floptical disk, and a hardware device specially configured to store and execute program instructions, such as a ROM, a RAM, and a flash memory. Examples of the program instruction include not only machine language codes such as codes generated by a compiler, but also high-level language codes that can be executed by a computer using an interpreter, or the like. The hardware device may be changed into one or more software modules to perform the processing according to the present disclosure, and vice versa.

Further, although the detailed description of the present disclosure has been described with reference to the preferred embodiments of the present disclosure, it will be understood by those skilled in the art or those with common knowledge in the art that the present disclosure can be variously modified and changed without departing from the spirit and technical scope of the present disclosure described in the claims to be described later. Therefore, the technical scope of the present disclosure should not be limited to the content described in the detailed description of the specification, but should be determined by the claims.

Further, although the detailed description of the present disclosure has been described with reference to the preferred embodiments of the present disclosure, it will be understood by those skilled in the art or those with common knowledge in the art that the present disclosure can be variously modified and changed without departing from the spirit and technical scope of the present disclosure described in the claims to be described later. Therefore, the technical scope of the present disclosure should not be limited to the content described in the detailed description of the specification, but should be determined by the claims.

What is claimed is:

1. A method for automatically transmitting a control signal based on a plurality of sub repeaters to provide a theme production service in an automatic transmission program executed by at least one processor of a main repeater, the method comprising:
linking to a plurality of sub repeaters having a plurality of prestored libraries and a terminal;
transmitting command data to at least one of the plurality of linked sub repeaters; and
performing control so that the sub repeater receiving the command data automatically transmits a control signal for activating the library included in the command data,
wherein the command data includes at least one of a sub repeater serial number, a library serial number, and setting information.

2. The method for automatically transmitting a control signal based on a plurality of sub repeaters of claim 1,
wherein the linking to the plurality of sub repeaters includes at least one of:
assigning a sub repeater serial number to each of the plurality of linked sub repeaters, and
acquiring a sub repeater serial number prestored for each of the plurality of linked sub repeaters.

3. The method for automatically transmitting a control signal based on a plurality of sub repeaters of claim 1,
wherein the linking to the terminal includes:
acquiring a plurality of libraries in which at least one emission pattern setting value is set from the linked terminal, and
extracting a library serial number matched with the acquired plurality of libraries.

4. The method for automatically transmitting a control signal based on a plurality of sub repeaters of claim 3, wherein the emission pattern setting value is data defining an emission form in which the light emitting device operates, and includes a setting value for at least one of an emission mode, an emission color, an emission time, luminous brightness, and an emission effect.

5. The method for automatically transmitting a control signal based on a plurality of sub repeaters of claim 1,
wherein the transmitting of the command data includes at least one of:
determining a first sub repeater based on the sub repeater serial number,
determining a first library to be transmitted from the first sub repeater based on the library serial number, and
setting first setting information including at least one of a signal radius, a propagation direction, and a reproduction mode of the control signal.

6. The method for automatically transmitting a control signal based on a plurality of sub repeaters of claim 5, further comprising:
providing a theme production service to at least one light emitting device operating according to the first library in response to the transmitted control signal, wherein
the providing of the theme production service includes performing control so that the first sub repeater transmits a control signal for causing light to be emitted according to the first library prestored in the first sub repeater to at least one light emitting device located within a first signal radius according to the set first setting information, and
the light emitting device emits light according to an emission pattern setting value included in the first library transmitted through the control signal.

7. The method for automatically transmitting a control signal based on a plurality of sub repeaters of claim 1, further comprising:
acquiring a scenario in which a library reproduction order is set for each sub repeater in advance; and
monitoring in real time the library transmitted through the control signal by at least one sub repeater based on the acquired scenario.

8. The method for automatically transmitting a control signal based on a plurality of sub repeaters of claim 7,
wherein the monitoring of the library transmitted through the control signal by the sub repeater in real time further includes:
detecting a first sub repeater transmitting a library not matched with the acquired scenario; and
adjusting the control signal transmitted to the first sub repeater so that the first sub repeater transmits a normal library preset for the acquired scenario.

9. A control signal automatic transmission system based on a plurality of sub repeaters, comprising:
a main repeater linked to a plurality of sub repeaters and including a control unit configured to remotely control the plurality of sub repeaters,
wherein the control unit:
is linked to a plurality of sub repeaters having a plurality of prestored libraries and a terminal,
transmits command data to at least one of the plurality of linked sub repeaters, and
controls the sub repeater receiving the command data so that the sub repeater automatically transmits a control signal for activating a library included in the command data, and
the command data includes at least one of a sub repeater serial number, a library serial number, and setting information.
